(19) United States
(12) Patent Application Publication
(10) Pub. No.: US 2026/0178722 A1
(43) Pub. Date: Jun. 25, 2026

(54) AUTHENTICATING FIRMWARE CODE LEVELS ASSOCIATED WITH INSTRUCTIONS

(71) Applicant: International Business Machines Corporation, Armonk, NY (US)

(72) Inventor: Louis P. GOMES, Poughkeepsie, NY (US)

(21) Appl. No.: 18/991,223

(22) Filed: Dec. 20, 2024

(51) Int. Cl. G06F 21/44

(52) U.S. Cl. CPC G06F 21/44; G06F 2221/033

(57) ABSTRACT

In some implementations, a computer system includes a processor set, one or more computer-readable storage media, and program instructions stored on the one or more computer-readable storage media. The program instructions cause the processor set to perform operations including obtaining, by an operating system service and from a program running on a device, a call indicative of a target central processor assist cryptographic facility (CPACF) instruction associated with the device and an instruction firmware code level (IFCL) hash associated with the target CPACF instruction. The operations further include performing, by the operating system service and based on the call, a query of a cryptographic certification library to generate a query result, and providing, based on the query, the query result to the program.

### BACKGROUND

The present invention relates to facilitating processing within a computing environment, and for example, relates to facilitating authenticating firmware code levels associated with instructions.

### SUMMARY

In one embodiment, a computer system is provided. In this embodiment, the computer system includes a processor set, one or more computer-readable storage media, and program instructions stored on the one or more computer-readable storage media to cause the processor set to perform operations. The operations include obtaining, by an operating system service and from a program running on a device, a call indicative of a target central processor assist cryptographic facility (CPACF) instruction associated with the device and an instruction firmware code level (IFCL) hash associated with the target CPACF instruction. The operations further include performing, by the operating system service and based on the call, a query of a cryptographic certification library to generate a query result, and providing, based on the query, the query result to the program.

In another embodiment, a computer-implemented method is provided. In this embodiment, the method includes providing, to an operating system service and by a program running on a device, a call indicative of a target CPACF instruction associated with the device and an IFCL hash associated with the target CPACF instruction. The method further includes obtaining, from the operating system service and based on the call, a query result associated with a query of a cryptographic certification library, the query result indicating whether the IFCL hash is a certified IFCL hash, and performing an action based on the query result.

In yet another embodiment, a computer program product is provided. In this embodiment, the computer program product includes one or more computer-readable storage media and program instructions stored on the one or more computer-readable storage media to perform operations. The operations include providing, to an operating system service and by a program running on a device, a call indicative of a target CPACF instruction associated with the device and an IFCL hash associated with the target CPACF instruction. The operations further include obtaining, from the operating system service and based on the call, a query result associated with a query of a cryptographic certification library, the query result indicating whether the IFCL hash is a certified IFCL hash, and performing an action based on the query result.

### BRIEF DESCRIPTION OF THE DRAWINGS

FIG. 1A is a block diagram of an example computing environment described herein.

FIG. 1B depicts further details of a processor of FIG. 1A.

FIG. 2 depicts another example of a computing environment described herein.

FIG. 3A depicts one format of a Compute Digital Signature Authentication (KDSA) instruction.

FIG. 3B depicts one example of a field of an implied register, general register 0, used by the instruction.

FIG. 3C depicts one example of function codes supported by the instruction.

FIG. 3D depicts one example of a field of an implied register, general register 1.

FIG. 3E depicts one example of contents of a register, R₂, specified by the Compute Digital Signature Authentication instruction.

FIG. 3F depicts one example of contents of a register, R₂+1, used by the Compute Digital Signature Authentication instruction.

FIG. 3G depicts an example of contents of parameter blocks used by various functions of the Compute Digital Signature Authentication instruction.

FIGS. 4A and 4B are schematic block diagrams showing an example process associated with authenticating firmware code levels associated with instructions.

FIG. 4C depicts an example of contents of a parameter block used by a Query-Authentication-Information function.

FIG. 5 is a diagram of an example computing environment in which systems and/or methods described herein may be implemented.

FIG. 6 is a diagram of example components of one or more devices of FIGS. 1A and 1B.

FIG. 7 is a flowchart of an example process associated with authenticating firmware code levels associated with instructions described herein.

FIG. 8 is a flowchart of an example process associated with authenticating firmware code levels associated with instructions described herein.

### DETAILED DESCRIPTION

The following detailed description of example implementations refers to the accompanying drawings. The same reference numbers in different drawings may identify the same or similar elements.

A digital signature may be used to verify the authenticity of digital messages. The sender of a message may sign the message with a digital signature and send the signed message to a recipient. The recipient may use the digital signature to verify the sender of the message and to confirm that the message has not been modified. To generate and/or verify a digital signature, an authentication technique may be used. Example authentication techniques may include the Elliptic Curve Digital Signature Algorithm (ECDSA), the Edwards-curve Digital Signature Algorithm (EdDSA), as well as others. Each authentication technique may be based on mathematical constructs. For instance, the Elliptic Curve Digital Signature Algorithm and the Edwards-curve Digital Signature Algorithm may use elliptic curves in generating and/or verifying a digital signature.

The algorithms may be implemented in software programs, which may be used to generate and/or verify digital signatures. The software programs may include many primitive software instructions used to generate the digital signature, and/or many primitive software instructions to verify the digital signature. In some cases, a capability may be provided to facilitate processing within a computing environment. As one example, a single instruction (e.g., a single architected hardware machine instruction at the hardware/software interface) may be provided to perform an operation, such as a compute digital signature authentication operation. The instruction may be part of a general-purpose processor instruction set architecture (ISA), which may be dispatched by a program (e.g., a user program) on a processor, such as a general-purpose processor.

In one example, the instruction, referred to as a Compute Digital Signature Authentication instruction (KDSA), is used to generate a signature for use in signing a message to be transmitted and for verifying the authenticity of the message when received. The instruction is, for instance, part of a message security assist extension (e.g., Message Security Assist Extension 9) facility of the z/Architecture® hardware architecture, offered by International Business Machines Corporation, Armonk, N.Y. The message security assist extension provides support for elliptical curve cryptography authentication of a message, generation of elliptical curve keys and scalar multiplication. The Compute Digital Signature Authentication instruction provides support for the signing and verification of elliptical curves. Functions provided by the instruction include, for instance: KDSA-Query, KDSA-ECDSA-Verify-P256, KDSA-ECDSA-Verify-P384, KDSA-ECDSA-Verify-P521, KDSA-ECDSA-Sign-P256, KDSA-ECDSA-Sign-P384, KDSA-ECDSA-Sign-P521, KDSA-Encrypted-ECDSA-Sign-P256, KDSA-Encrypted-ECDSA-Sign-P384, KDSA-Encrypted-ECDSA-Sign-P521, KDSA-EdDSA-Verify-Ed25519, KDSA-EdDSA-Verify-Ed448, KDSA-EdDSA-Sign-Ed25519, KDSA-EdDSA-Sign-Ed448, KDSA-Encrypted-EdDSA-Sign-Ed25519, and KDSA-Encrypted-EdDSA-Sign-Ed448. These functions, except for the query function, may be used in signing and verifying messages using various techniques for different National Institute of Standards and Technology (NIST) primes.

In computing environments, cryptographic operations play an important role in data security and integrity. Central Processor Assist for Cryptographic Function (CPACF) instructions, such as the KDSA instruction, may provide hardware-accelerated support for various cryptographic algorithms. These instructions may enhance performance and security for operations like digital signature generation and verification. As the complexity and diversity of cryptographic operations increase, verifying the authenticity and integrity of the firmware code associated with these instructions may become an important consideration.

One aspect to consider is verifying that the firmware code level of a CPACF instruction has been certified by an official certification authority before it is used by software applications. This verification may help maintain the security and trustworthiness of cryptographic operations, especially in environments where firmware updates or changes may occur. Relying solely on hardware-level checks or manual verification processes may not always account for dynamic changes in firmware or potential security vulnerabilities introduced during updates.

Additionally, the increasing frequency of firmware updates and the potential for malicious code injection may present challenges. Software applications may benefit from a reliable and efficient method to authenticate the firmware code level of CPACF instructions in real-time, without significantly impacting performance or requiring extensive modifications to existing systems. A standardized, software-driven approach to this authentication process may help address potential inconsistencies across different applications and security considerations.

Implementations of this disclosure address problems such as these by providing a system and method for authenticating firmware code levels associated with instructions before using those instructions. The system obtains, by an operating system service and from a program running on a device, a call indicative of a target CPACF instruction associated with the device and an instruction firmware code level (IFCL) hash associated with the target CPACF instruction. As used herein, a device may include a computing device (machine) that is capable of executing cryptography (or other) instructions whose firmware code level is to be certified. As used herein, the term “CPACF instruction” refers to any hardware-accelerated cryptographic instruction, including but not limited to instructions for encryption, decryption, digital signatures, and hashing. The system then performs, by the operating system service and based on the call, a query of a cryptographic certification library to generate a query result. The cryptographic certification library may contain a set of certified IFCL hash lists, each corresponding to a respective CPACF instruction. The system provides, based on the query, the query result to the program.

The query result indicates whether the IFCL hash associated with the target CPACF instruction is a certified IFCL hash. As used herein, a “certified IFCL hash” refers to a hash value that has been verified and approved by a trusted certification authority. If the query result indicates that the IFCL hash is not a certified IFCL hash, the program refrains from using the target CPACF instruction and may report that the instruction will not be used. This reporting may be done to the operating system, a log file, or a monitoring console. Conversely, if the query result indicates that the IFCL hash is a certified IFCL hash, the program may proceed to use the target CPACF instruction. This approach ensures that only authenticated and trusted firmware code levels are utilized, mitigating the risk of using potentially compromised or outdated instructions.

Implementations of this disclosure further address the challenge of dynamic firmware updates by periodically checking the IFCL hash and version number. The system may determine that an IFCL version number associated with the IFCL hash has changed. As used herein, the term “IFCL version number” refers to a unique identifier associated with a specific release or update of the instruction's firmware code. The system reports that the IFCL version number has changed, which may occur while the program is running. This real-time reporting allows for immediate awareness of firmware updates or potential security issues. Based on determining that the IFCL version number has changed, the system may stop the use of the target CPACF instruction. To maintain ongoing security, the program may provide, in accordance with a periodicity, at least one additional call to the operating system service. This periodicity may be configurable and can range from seconds to hours or days, depending on the security requirements of the system.

In some implementations, the operating system obtains certified IFCL hashes from a certificate authority and creates a certified IFCL hash list for each CPACF instruction. Accordingly, an advantage of the operating system creating and maintaining a centralized repository of certified IFCL hashes is that it provides a single, authoritative source of truth for all programs to reference when authenticating CPACF instructions. Additionally, an advantage of the centralized certified IFCL hash list is that it simplifies the process of updating and maintaining the list of certified hashes across the entire system, reducing the risk of inconsistencies or outdated information being used by different programs.

In some implementations, the program periodically checks the IFCL hash and version number while the program is running. Accordingly, an advantage of the periodic checking is that it allows for real-time detection of firmware changes or potential security issues, even after the initial authentication of the CPACF instruction. Additionally, an advantage of the periodic checking is that it provides ongoing assurance of the integrity and authenticity of the CPACF instruction throughout the entire runtime of the program, rather than just at the initial execution.

In some implementations, the program reports changes in the IFCL version number while the program is running. Accordingly, an advantage of reporting version number changes is that it provides immediate awareness of firmware updates or potential security vulnerabilities, allowing for prompt investigation and mitigation of any issues. Additionally, an advantage of reporting version number changes is that it aids in debugging and troubleshooting by providing clear indicators of when firmware changes occurred, which can be correlated with any observed changes in system behavior or performance.

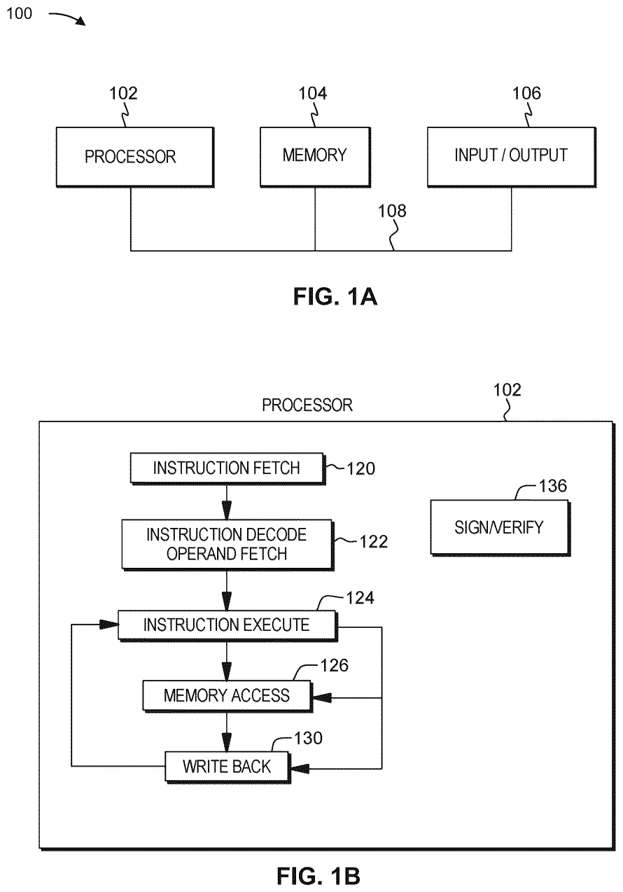

One embodiment of a computing environment to incorporate and use one or more aspects of the present invention is described with reference to FIG. 1A. A computing environment 100 includes, for instance, a processor 102 (e.g., a central processing unit), a memory 104 (e.g., main memory; a.k.a., system memory, main storage, central storage, storage), and one or more input/output (I/O) devices and/or interfaces 106 coupled to one another via, for example, one or more buses 108 and/or other connections.

In one example, processor 102 is based on the z/Architecture hardware architecture offered by International Business Machines Corporation, Armonk, N.Y., and is part of a server, such as an IBM Z® server, which is also offered by International Business Machines Corporation and implements the z/Architecture hardware architecture. The z/Architecture hardware architecture, however, is only one example architecture; other architectures and/or other types of computing environments may include and/or use one or more aspects of the present invention. In one example, the processor executes an operating system, such as the z/OS® operating system, also offered by International Business Machines Corporation.

Processor 102 includes a plurality of functional components used to execute instructions. As depicted in FIG. 1B, these functional components include, for instance, an instruction fetch component 120 to fetch instructions to be executed; an instruction decode unit 122 to decode the fetched instructions and to obtain operands of the decoded instructions; an instruction execute component 124 to execute the decoded instructions; a memory access component 126 to access memory for instruction execution, if necessary; and a write back component 130 to provide the results of the executed instructions.

The various components of FIGS. 1A and 1B may be utilized to implement inventive methods as described herein. For instance, the processor 102 may execute the operating system service that receives the call from a program running on the device. The instruction fetch component 120 and instruction decode unit 122 may work together to identify the target CPACF instruction and its associated IFCL hash. The memory access component 126 may be used to query the cryptographic certification library stored in memory 104. The instruction execute component 124 may perform the comparison between the IFCL hash and the certified IFCL hashes in the library. The write back component 130 may provide the query result back to the program. Additionally, the I/O devices and interfaces 106 may be used for reporting changes in IFCL version numbers or instruction usage status. This implementation leverages the existing hardware architecture to provide a robust and efficient method for authenticating firmware code levels associated with CPACF instructions.

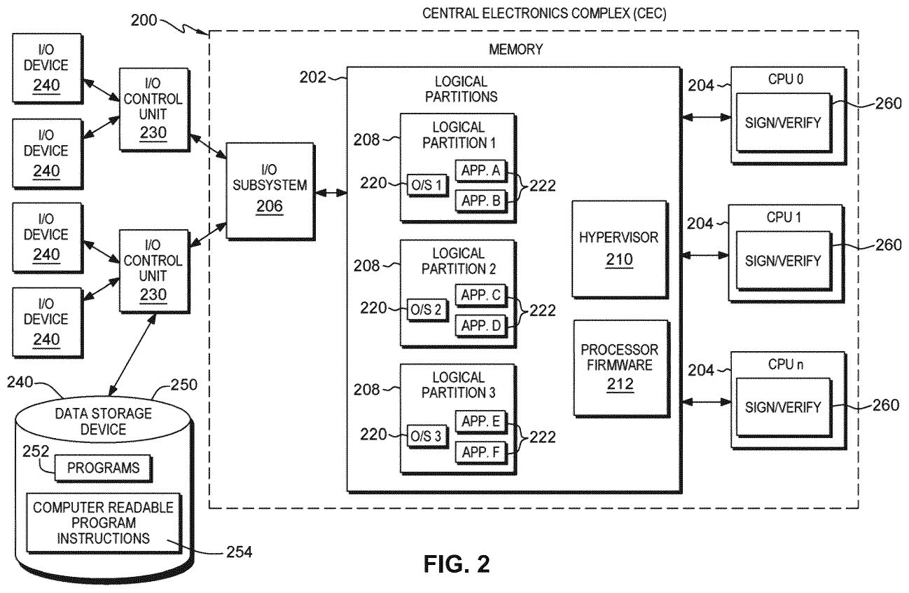

Another example of a computing environment to incorporate and use one or more aspects of the present invention is described with reference to FIG. 2. In one example, the computing environment is based on the z/Architecture hardware architecture; however, the computing environment may be based on other architectures offered by International Business Machines Corporation or others.

Referring to FIG. 2, in one example, the computing environment includes a central electronics complex (CEC) 200. CEC 200 includes a plurality of components, such as, for instance, a memory 202 (a.k.a., system memory, main memory, main storage, central storage, storage) coupled to one or more processors (a.k.a., central processing units (CPUs)) 204, and to an input/output subsystem 206.

Memory 202 includes, for example, one or more logical partitions 208, a hypervisor 210 that manages the logical partitions, and processor firmware 212. One example of hypervisor 210 is the Processor Resource/System Manager (PR/SM) hypervisor, offered by International Business Machines Corporation, Armonk, N.Y. As used herein, firmware includes, e.g., the microcode of the processor. It includes, for instance, the hardware-level instructions and/or data structures used in implementation of higher-level machine code. In one embodiment, it includes, for instance, proprietary code that is typically delivered as microcode that includes trusted software or microcode specific to the underlying hardware and controls operating system access to the system hardware.

Each logical partition 208 is capable of functioning as a separate system. That is, each logical partition can be independently reset, run a guest operating system 220 such as a z/OS operating system, or another operating system, and operate with different programs 222. An operating system or application program running in a logical partition appears to have access to a full and complete system, but in reality, only a portion of it is available.

Memory 202 is coupled to processors (e.g., CPUs) 204, which are physical processor resources that may be allocated to the logical partitions. For instance, a logical partition 208 includes one or more logical processors, each of which represents all or a share of a physical processor resource 204 that may be dynamically allocated to the logical partition.

Further, memory 202 is coupled to I/O subsystem 206. I/O subsystem 206 may be a part of the central electronics complex or separate therefrom. It directs the flow of information between main storage 202 and input/output control units 230 and input/output (I/O) devices 240 coupled to the central electronics complex.

Many types of I/O devices may be used. One particular type is a data storage device 250. Data storage device 250 may store one or more programs 252, one or more computer readable program instructions 254, and/or data, etc. The computer readable program instructions may be configured to carry out functions of embodiments of aspects of the invention.

Central electronics complex 200 may include and/or be coupled to removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with central electronics complex 200. Examples include, but are not limited to: microcode, device drivers, redundant processing units, external disk drive arrays, RAID systems, tape drives, and data archival storage systems, etc.

Further, central electronics complex 200 may be operational with numerous other general purpose or special purpose computing system environments or configurations. Examples of well-known computing systems, environments, and/or configurations that may be suitable for use with central electronics complex 200 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Although various examples of computing environments are described herein, one or more aspects of the present invention may be used with many types of environments. The computing environments provided herein are only examples.

The various components of FIG. 2 may be utilized to implement the inventive methods as described herein. For instance, the processors 204 may execute the operating system service that receives the call from a program running in one of the logical partitions 208. The hypervisor 210 may manage access to the cryptographic certification library stored in memory 202. The processor firmware 212 may include the target CPACF instruction and its associated IFCL hash. The I/O subsystem 206 may be used to query external sources for certified IFCL hashes. The guest operating system 220 running in a logical partition may provide the program that initiates the authentication process. The programs 222 may include the cryptographic operations that utilize the authenticated CPACF instructions. The data storage device 250 may store the cryptographic certification library and logs of IFCL version changes. The computer readable program instructions 254 may implement the logic for determining whether to use or refrain from using a CPACF instruction based on the authentication result. This implementation leverages the logical partitioning and virtualization capabilities of the central electronics complex to provide a secure and efficient method for authenticating firmware code levels associated with CPACF instructions across multiple isolated environments.

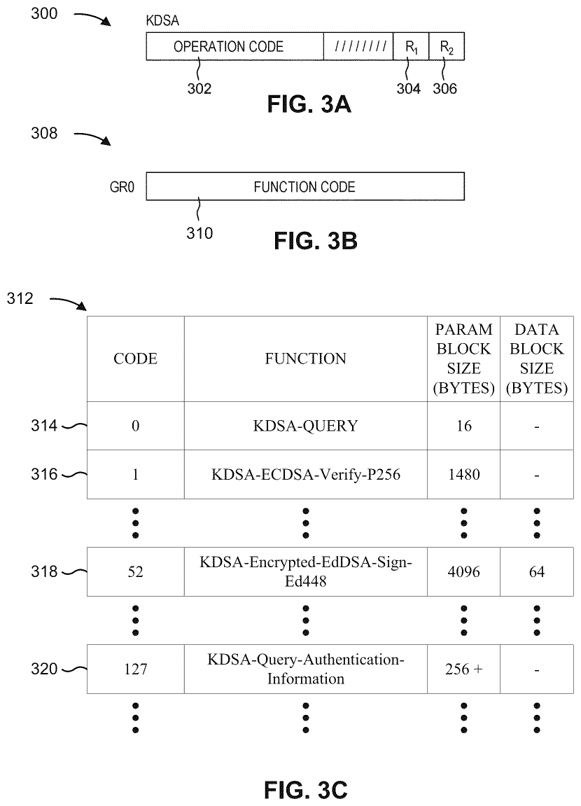

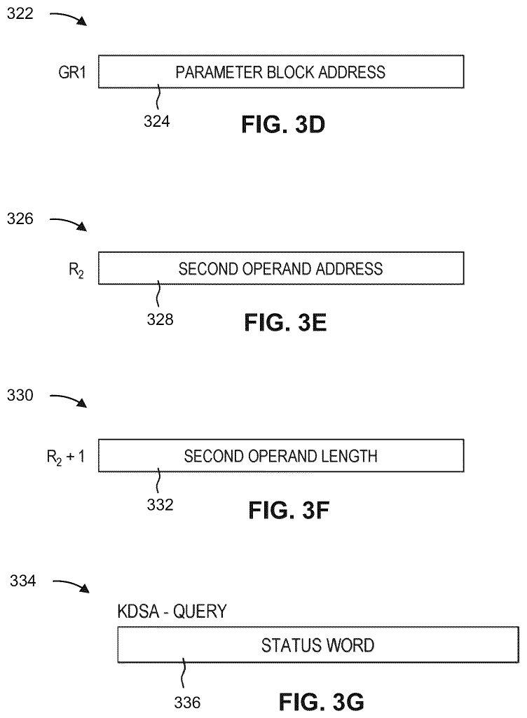

One embodiment of the Compute Digital Signature Authentication (KDSA) instruction is described with reference to FIGS. 3A-3F. The instruction is executed, in one example, using a processor, such as a general-purpose processor (e.g., processor 102 or 204). In the description herein, specific locations, specific fields and/or specific sizes of the fields are indicated (e.g., specific bytes and/or bits). However, other locations, fields and/or sizes may be provided. Further, although the setting of a bit to a particular value, e.g., one or zero, is specified, this is only an example. The bit may be set to a different value, such as the opposite value or to another value, in other examples. Many variations are possible.

Referring to FIG. 3A, in one example, the format of a Compute Digital Signature Authentication (KDSA) instruction 300 is an RRE format that denotes a register and register operation with an extended operation code (opcode) field. As an example, the instruction includes an operation code field 302 (e.g., bits 0-15) having an operation code indicating a compute digital signature authentication operation; a first register field (R₁) 304 (e.g., bits 24-27), which is reserved, in one example, and should include zeros; and a second register field (R₂) 306 (e.g., bits 28-31) designating a pair of general registers. The contents of a register designated by R₂ field 306 specify a location of a second operand (in storage). The contents of R₂+1 specify the length of the second operand. In one example, bits 16-23 of the instruction are reserved and should contain zeros; otherwise, the program may not operate compatibly in the future. As used herein, the program is the one issuing the instruction. It may be a user program or another type of program.

In one embodiment, execution of the instruction includes the use of one or more implied general registers (i.e., registers not explicitly designated by the instruction). For instance, general registers 0 and 1 are used in execution of the instruction, as described herein. In one example, general register 0 contains various controls affecting the operation of the instruction, and general register 1 is used to provide a location of a parameter block used by the instruction.

As an example, with reference to FIG. 3B, a general register 0 (308) includes a function code field 310 that includes a function code. In one particular example, bit positions 57-63 of general register 0 contain the function code; in other embodiments, other bits may be used to contain the function code. Further, bits 0-31 of general register 0 are ignored, and bits 32-56 are reserved and should contain zeros; otherwise, the program may not operate compatibly in the future. When bits 57-63 of general register 0 designate an unassigned or uninstalled function code, a specification exception is recognized, in one example.

Example assigned function codes for the Compute Digital Signature Authentication (KDSA) instruction are shown in the table 312 of FIG. 3C and include, for instance: function code 0 (314) indicating a KDSA-Query function; function code 1 (316) indicating a KDSA-ECDSA-Verify-P256 function; function code 52 (318) indicating a KDSA-Encrypted-EdDSA-Sign-Ed448 function; and function code indicating a query authentication information (QAI) function.

Each function uses a parameter block and the size of the parameter block depends, in one example, on the function. Example parameter block sizes for the functions are depicted in FIG. 3C, as well as example data block sizes, if applicable. Other function codes are unassigned in this example. Although example functions and function codes are described, other functions and/or function codes may be used.

A parameter block is specified by, for instance, general register 1. In one example, referring to FIG. 3D, the contents of general register 1 (322) specify, for instance, a logical address 324 of the leftmost byte of a parameter block in storage. For instance, in the 24-bit addressing mode, the contents of bit positions 40-63 of general register 1 constitute the address and the contents of bit positions 0-39 are ignored. In the 31-bit addressing mode, the contents of bit positions 33-63 of general register 1 constitute the address, and the contents of bit positions 0-32 are ignored. In the 64-bit addressing mode, the contents of bit positions 0-63 of general register 1 constitute the address. In the access register mode, access register 1 specifies the address space containing the parameter block. Additional details regarding the parameter block for the various functions are described further below.

Returning to FIG. 3A, R₂ field 306 designates an even-odd pair of general registers and is to designate, for instance, an even-numbered register other than general register 0; otherwise, a specification exception is recognized. As shown in FIG. 3E, the contents of a general register R₂ (326) indicate a second operand address 328. For instance, the location of the leftmost byte of the second operand is specified by the contents of the R₂ general register, depending on the addressing mode. In one embodiment, in the 24-bit addressing mode, the contents of bit positions 40-63 of general register R₂ constitute the address of the second operand, and the contents of bit positions 0-39 are ignored; bits 40-63 of the updated address replace the corresponding bits in general register R₂, carries out of bit position 40 of the updated address are ignored, and the contents of bit positions 32-39 of general register R₂ are set to zeros. In the 31-bit addressing mode, the contents of bit positions 33-63 of general register R₂ constitute the address of the second operand, and the contents of bit positions 0-32 are ignored; bits 33-63 of the updated address replace the corresponding bits in general register R₂, carries out of bit position 33 of the updated address are ignored, and the content of bit position 32 of general register R₂ is set to zero. In the 64-bit addressing mode, the contents of bit positions 0-63 of general register R₂ constitute the address of the second operand; bits 0-63 of the updated address replace the contents of general register R₂ and carries out of bit position 0 are ignored.

The number of bytes in the second operand location is specified in general register R₂+1. As shown in FIG. 3F, the contents of general register R₂+1 (330) are used to determine the length 332 of the second operand. In one embodiment, in both the 24-bit and the 31-bit addressing modes, the contents of bit positions 32-63 of general register R₂+1 form a 32-bit unsigned binary integer which specifies the number of bytes in the second operand; and the updated value replaces the contents of bit positions 32-63 of general register R₂+1. In the 64-bit addressing mode, the contents of bit positions 0-63 of general register R₂+1 form a 64-bit unsigned binary integer which specifies the number of bytes in the second operand; and the updated value replaces the contents of general register R2+1.

In the 24-bit or 31-bit addressing mode, the contents of bit positions 0-31 of general registers R2 and R2+1 remain unchanged. In access register mode, access register R2 specifies the address space for the second operand. In one example, the Edwards-curve operands are byte-wise ordered in the little-endian format and the second operand is likewise ordered within the second operand address space.

One example of a parameter block used by the query function is described with reference to FIG. 3G. As shown, in one example, a parameter block 334 includes a 128-bit status word 336. Bits 0-127 of this field correspond to function codes 0-127, respectively, of the Compute Digital Signature Authentication instruction. When a bit is, e.g., one, the corresponding function is installed; otherwise, the function is not installed.

As an example, condition code 0 is set when execution of the KDSA-Query function completes; condition codes 1, 2 and 3 are not applicable to this function.

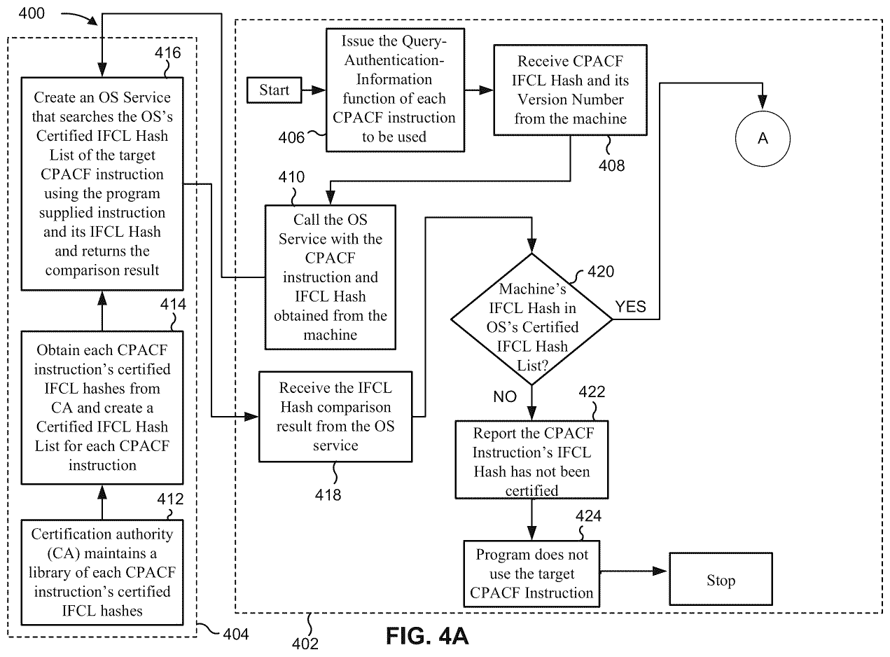

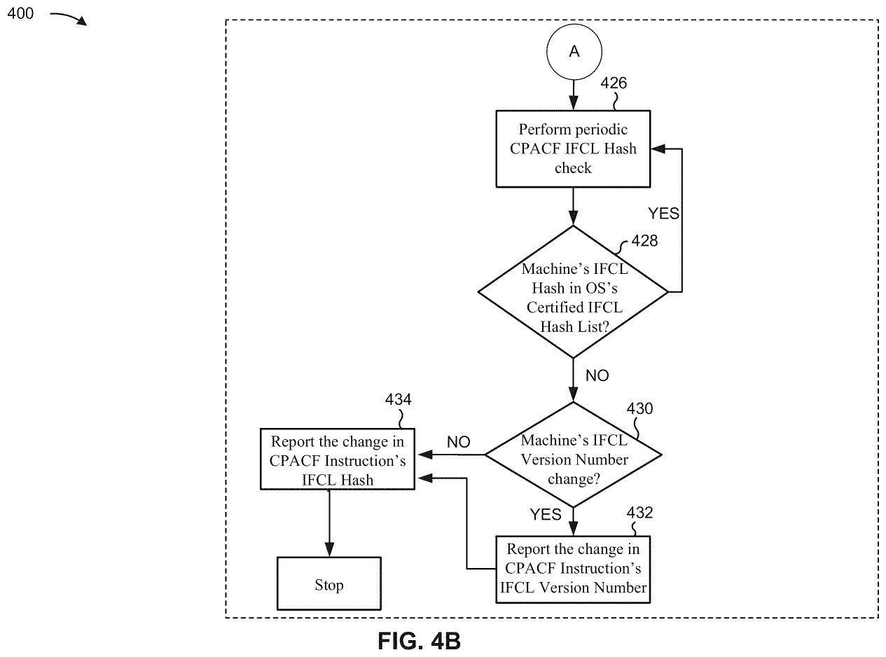

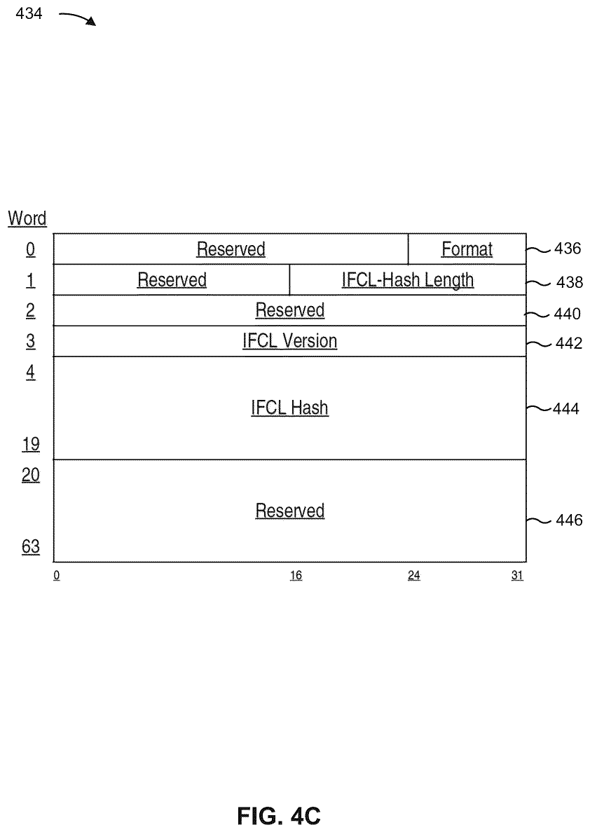

While the KDSA instruction provides powerful cryptographic capabilities, it may be vulnerable to potential security risks if the firmware code level associated with the instruction is not properly authenticated. This issue becomes particularly significant in environments where firmware updates occur frequently or where there is a risk of malicious code injection. To address this concern, a system and method for authenticating firmware code levels associated with instructions before their use is introduced. This approach enhances the security and trustworthiness of cryptographic operations by ensuring that only verified and certified firmware code levels are utilized. FIG. 4A illustrates an example process associated with authenticating firmware code levels for CPACF instructions, providing a robust mechanism to maintain the integrity of cryptographic operations in dynamic computing environments.

FIGS. 4A and 4B illustrate schematic block diagrams showing an example process 400 associated with authenticating firmware code levels associated with instructions. The process 400 involves interactions between a program 402 and an operating system 404. This process may address the technical challenge of ensuring the integrity and authenticity of firmware code levels for cryptographic instructions in dynamic computing environments where frequent updates or potential security risks may exist.

The process 400 begins with step 406, where the program 402 issues a Query-Authentication-Information function for each CPACF instruction to be used. This step initiates the authentication process by requesting information about the firmware code level associated with specific cryptographic instructions. In some implementations, the Query-Authentication-Information function may be implemented as a dedicated API call or as part of a broader system integrity check routine.

In step 408, the program 402 receives the CPACF IFCL hash and its version number from the machine. The IFCL hash is a unique identifier generated from the firmware code associated with a particular CPACF instruction. The version number provides additional context about the firmware's revision history. In some implementations, the hash and version number may be combined into a single identifier or supplemented with additional metadata about the firmware.

The process 400 then moves to step 410, where the program 402 calls the OS Service with the CPACF instruction and IFCL hash obtained from the machine. This step represents the program's request to the operating system to verify the authenticity of the firmware code level. The OS Service may act as an intermediary between the program and the cryptographic certification library, providing a standardized interface for authentication requests.

The operating system 404 performs several steps to support this process. In step 412, a Certification Authority (CA) maintains a library of each CPACF instruction's certified IFCL hashes. This library may serve as a repository of known-good firmware code levels. The CA may be an external entity or an internal component of the system, depending on the specific implementation and security requirements.

Step 414 involves obtaining each CPACF instruction's certified IFCL hashes from the CA and creating a certified IFCL hash List for each CPACF instruction. The operating system may store the certified IFCL hash list in a cryptographic certification library. This step may ensure that the operating system has an up-to-date local copy of the certified hashes, which can be used for efficient verification without the need to query the CA for every authentication request. In some implementations, this step may be performed periodically or triggered by specific events, such as system updates or security alerts.

In step 416, the OS creates a service that searches (e.g., queries) the OS's certified IFCL Hash List of the target CPACF instruction in the cryptographic certification library using the program-supplied instruction and its IFCL Hash, and returns the query result. Searching the OS's certified IFCL Hash List may include comparing the IFCL hash received from the program 402 to the certified IFCL hashes in the cryptographic certification library to determine whether there is a match. Identifying a match may be equivalent to determining that the IFCL hash received from the program 402 is the same as a certified IFCL hash in the cryptographic certification library. At step 418, the program 402 receives the IFCL hash comparison result (e.g., the query result). This service may encapsulate the logic for comparing the provided hash against the list of certified hashes, abstracting the complexity of the verification process from the calling program.

The process 400 then enters a decision phase. In step 420, it checks if the machine's IFCL Hash is in the OS's Certified IFCL Hash List. This comparison determines whether the firmware code level of the CPACF instruction is recognized and approved by the certification authority. The outcome of this check may dictate the subsequent actions of the program.

If the hash is not certified (NO branch from step 420), the process 400 moves to step 422, where it reports the CPACF Instruction's IFCL hash has not been certified. This reporting mechanism may alert system administrators or security personnel to potential integrity issues or unauthorized modifications to the firmware. The reporting may take various forms, such as log entries, system alerts, or notifications to monitoring services.

Following the reporting, step 424 is executed, where the program does not use the target CPACF Instruction. This precautionary measure may prevent the use of potentially compromised or unauthorized firmware, mitigating security risks. In some implementations, the program may attempt to use alternative instructions or fall back to software-based cryptographic operations if available.

If the hash is certified (YES branch from step 420), the process 400 proceeds to step 426, where it performs periodic CPACF IFCL hash checks, as shown in FIG. 4B. These ongoing verifications may help ensure continued integrity of the firmware code level throughout the program's execution. The frequency of these checks may be configurable based on system requirements and security policies.

The periodic checks lead to another decision in step 428, checking if the machine's IFCL hash is in the OS's Certified IFCL Hash List. This step may allow for detection of any changes to the firmware code level that may occur during runtime, such as through dynamic updates or potential security breaches.

If the hash is not certified during these periodic checks (NO branch from step 428), the process 400 moves to step 430 to check if the machine's IFCL Version Number has changed. This additional check may help distinguish between legitimate firmware updates and potential security issues.

If the version number has changed (YES branch from step 430), the process 400 proceeds to step 432, where it reports the change in CPACF Instruction's IFCL Version Number. This reporting may provide visibility into firmware update activities and allow for appropriate responses to version changes. The process 400 may proceed to step 434 to report the change in CPACF Instruction's IFCL hash.

If the version number hasn't changed (NO branch from step 430), the process 400 returns to step 434 to report the change in CPACF Instruction's IFCL hash. This path may handle scenarios where the hash has changed without a corresponding version number update, which may indicate unauthorized modifications to the firmware.

FIG. 4C illustrates a block diagram of a parameter block 434 used in a system for authenticating an instruction's firmware code level. The parameter block 434 is structured as a series of words, each containing specific fields related to the IFCL authentication process. The parameter block 434 begins with Word 0, which includes a reserved field and a format field 436. The format field 436 is positioned at the end of Word 0 and specifies the format version of the parameter block. This field may allow for future extensibility of the parameter block structure while maintaining backward compatibility.

Word 1 contains a reserved field and an IFCL-Hash Length field 438. The IFCL-Hash Length field 438 indicates the length of the IFCL hash stored in the parameter block. This variable-length approach may accommodate different hash algorithms and sizes that may be used in various implementations or future enhancements of the system. Word 2 is entirely occupied by a reserved field 440, which may be used for future expansions or system-specific purposes. The presence of reserved fields throughout the parameter block may provide flexibility for adding new features or data elements without requiring a complete redesign of the structure.

Word 3 contains the IFCL Version field 442, which stores the version number of the instruction firmware code level being authenticated. This field may allow for tracking and comparing firmware versions, enabling the system to detect and respond to version changes appropriately. Words 4 through 19 comprise the IFCL Hash field 444. This field stores the actual hash value of the instruction firmware code level, which is used in the authentication process. The variable size of this field, as specified by the IFCL-Hash Length field 438, may allow for different hash algorithms to be used without changing the overall structure of the parameter block. Words 20 through 63 are designated as a reserved field 446, providing space for potential future additions or modifications to the parameter block structure. This large reserved area may ensure that the parameter block can accommodate significant expansions in functionality without requiring changes to existing implementations.

The layout of the parameter block 434 may allow for efficient storage and retrieval of the necessary information for authenticating the instruction firmware code level. The use of reserved fields and a flexible hash length may provide adaptability to future requirements and different cryptographic algorithms.

This system and method for authenticating firmware code levels associated with instructions may provide several technical advantages. First, it may enhance the security of cryptographic operations by ensuring that only certified firmware code levels are used, potentially reducing the risk of compromised or malicious code execution. Second, the periodic checking mechanism may allow for real-time detection of firmware changes, enabling prompt responses to potential security threats. Third, the separation of concerns between the program, operating system service, and certification authority may provide a modular and scalable approach to firmware authentication.

The disclosure may also offer flexibility in implementation. For example, the cryptographic certification library could be implemented as a local database, a distributed ledger, or a cloud-based service, depending on the specific security requirements and infrastructure of the system. The periodic checking mechanism can be adjusted to balance security needs with performance considerations, allowing for customization based on the deployment environment.

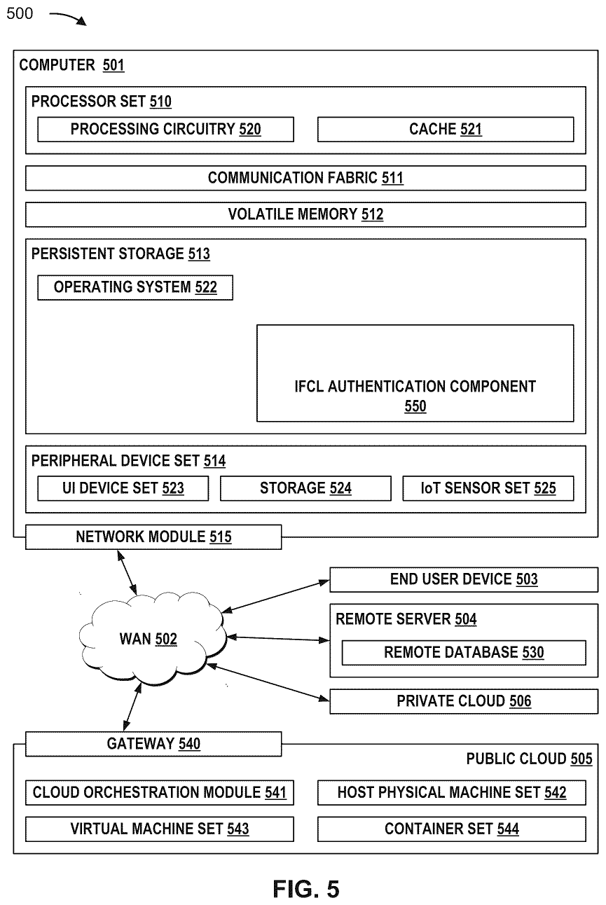

FIG. 5 is a diagram of an example computing environment 500 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code involved in performing the inventive methods, such as an IFCL authentication component, shown in block 550. In addition to block 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 550 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 550 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501) and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

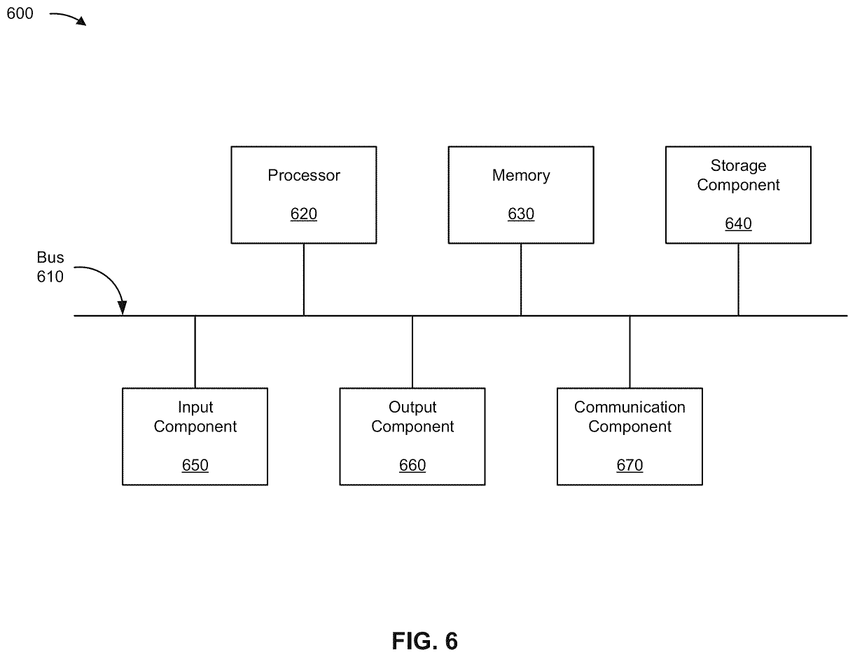

FIG. 6 is a diagram of example components of a device 600, which may implement one or more components of the computing environment 100. As shown in FIG. 6, device 600 may include a bus 610, a processor 620, a memory 630, a storage component 640, an input component 650, an output component 660, and a communication component 670.

Bus 610 includes a component that enables wired and/or wireless communication among the components of device 600. Processor 620 includes a central processing unit, a graphics processing unit, a microprocessor, a controller, a microcontroller, a digital signal processor, a field-programmable gate array, an application-specific integrated circuit, and/or another type of processing component. Processor 620 is implemented in hardware, firmware, or a combination of hardware and software. In some implementations, processor 620 includes one or more processors capable of being programmed to perform a function. Memory 630 includes a random access memory, a read only memory, and/or another type of memory (e.g., a flash memory, a magnetic memory, and/or an optical memory).

Storage component 640 stores information and/or software related to the operation of device 600. For example, storage component 640 may include a hard disk drive, a magnetic disk drive, an optical disk drive, a solid state disk drive, a compact disc, a digital versatile disc, and/or another type of non-transitory computer-readable medium. Input component 650 enables device 600 to receive input, such as user input and/or sensed inputs. For example, input component 650 may include a touch screen, a keyboard, a keypad, a mouse, a button, a microphone, a switch, a sensor, a global positioning system component, an accelerometer, a gyroscope, and/or an actuator. Output component 660 enables device 600 to provide output, such as via a display, a speaker, and/or one or more light-emitting diodes. Communication component 670 enables device 600 to communicate with other devices, such as via a wired connection and/or a wireless connection. For example, communication component 670 may include a receiver, a transmitter, a transceiver, a modem, a network interface card, and/or an antenna.

Device 600 may perform one or more processes described herein. For example, a non-transitory computer-readable medium (e.g., memory 630 and/or storage component 640) may store a set of instructions (e.g., one or more instructions, code, software code, and/or program code) for execution by processor 620. Processor 620 may execute the set of instructions to perform one or more processes described herein. In some implementations, execution of the set of instructions, by one or more processors 620, causes the one or more processors 620 and/or the device 600 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 6 are provided as an example. Device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

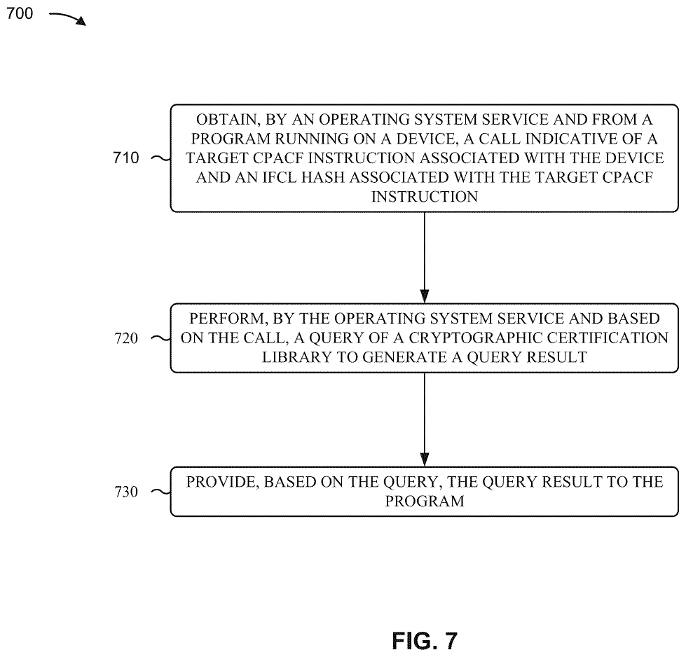

FIG. 7 is a flowchart of an example process 700 associated with IFCL authentication as described herein. In some implementations, one or more process blocks of FIG. 7 may be performed by a processor (e.g., processor 102 or one or more components thereof). Additionally, or alternatively, one or more process blocks of FIG. 7 may be performed by one or more components of device 600, such as processor 620, memory 630, storage component 640, input component 650, output component 660, and/or communication component 670.

As shown in FIG. 7, process 700 may include obtaining, by an operating system service and from a program running on a device, a call indicative of a target CPACF instruction associated with the device and an IFCL hash associated with the target CPACF instruction (block 710). For example, the processor may obtain, by an operating system service and from a program running on a device, a call indicative of a target CPACF instruction associated with the device and an IFCL hash associated with the target CPACF instruction, as described above.

As shown in FIG. 7, process 700 may include performing, by the operating system service and based on the call, a query of a cryptographic certification library to generate a query result (block 720). For example, the processor may perform, by the operating system service and based on the call, a query of a cryptographic certification library to generate a query result, as described above. In some implementations, performing the query may include querying a set of certified IFCL hash lists for a match between the IFCL hash associated with the target CPACF instruction and a certified IFCL hash.

As shown in FIG. 7, process 700 may include providing, based on the query, the query result to the program (block 730). For example, the processor may provide, based on the query, the query result to the program, as described above.

In some implementations, the query result indicates that the IFCL hash associated with the target CPACF instruction is not a certified IFCL hash. In some implementations, the query result indicates that the IFCL hash associated with the target CPACF instruction is a certified IFCL hash. In some implementations, process 700 may include obtaining, by the operating system and from a certificate authority, a plurality of certified IFCL hashes; and generating, in the cryptographic certification library, the set of certified IFCL hash lists, each IFCL hash list of the set of certified IFCL hash lists corresponding to a respective CPACF instruction of a set of CPACF instructions.

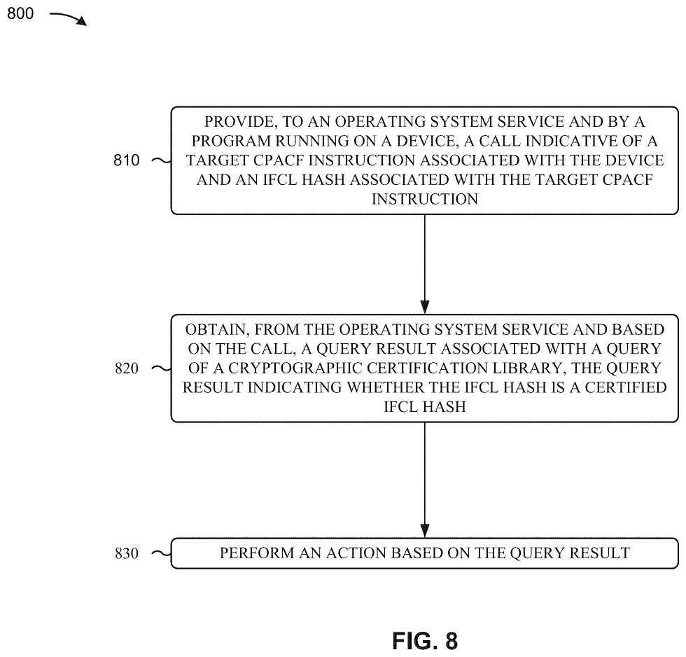

FIG. 8 is a flowchart of an example process 800 associated with IFCL authentication as described herein. In some implementations, one or more process blocks of FIG. 8 may be performed by a processor (e.g., processor 102 or one or more components thereof). Additionally, or alternatively, one or more process blocks of FIG. 8 may be performed by one or more components of device 600, such as processor 620, memory 630, storage component 640, input component 650, output component 660, and/or communication component 670.

As shown in FIG. 8, process 800 may include providing, to an operating system service and by a program running on a device, a call indicative of a target CPACF instruction associated with the device and an IFCL hash associated with the target CPACF instruction (block 810). For example, the processor may provide, to an operating system service and by a program running on a device, a call indicative of a target CPACF instruction associated with the device and an IFCL hash associated with the target CPACF instruction, as described above.

As shown in FIG. 8, process 800 may include obtaining, from the operating system service and based on the call, a query result associated with a query of a cryptographic certification library, the query result indicating whether the IFCL hash is a certified IFCL hash (block 820). For example, the processor may obtain, from the operating system service and based on the call, a query result associated with a query of a cryptographic certification library, the query result indicating whether the IFCL hash is a certified IFCL hash, as described above.

As shown in FIG. 8, process 800 may include providing, based on the query, the query result to the program (block 830). For example, the processor may provide, based on the query, the query result to the program, as described above.

In some implementations, the action may include refraining from using the target CPACF instruction if the query result indicates that the IFCL hash is not a certified IFCL hash. In some implementations, process 800 may include reporting that the target CPACF instruction will not be used. In some implementations, the action may include using the target CPACF instruction if the query result indicates that the IFCL hash is a certified IFCL hash.

In some implementations, process 800 may include determining that an IFCL version number associated with the IFCL hash has changed. In some implementations, process 800 may include reporting that the IFCL version number has changed. In some implementations, reporting that the IFCL version number has changed may include reporting that the IFCL version number has changed while the program is running. In some implementations, process 800 may include stopping, based on determining that the IFCL version number has changed, use of the target CPACF instruction. In some implementations, process 800 may include providing, in accordance with a periodicity, at least one additional call to the operating system service.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer system comprising:
a processor set;
one or more computer-readable storage media; and
program instructions stored on the one or more computer-readable storage media to cause the processor set to perform operations comprising:
obtaining, by an operating system service and from a program running on a device, a call indicative of a target central processor assist cryptographic facility (CPACF) instruction associated with the device and an instruction firmware code level (IFCL) hash associated with the target CPACF instruction;
performing, by the operating system service and based on the call, a query of a cryptographic certification library to generate a query result; and
providing, based on the query, the query result to the program.

2. The computer system of claim 1, wherein the query result indicates that the IFCL hash associated with the target CPACF instruction is not a certified IFCL hash.

3. The computer system of claim 1, wherein the query result indicates that the IFCL hash associated with the target CPACF instruction is a certified IFCL hash.

4. The computer system of claim 1, wherein performing the query comprises querying a set of certified IFCL hash lists for a match between the IFCL hash associated with the target CPACF instruction and a certified IFCL hash.

5. The computer system of claim 4, further comprising:
obtaining, by the operating system and from a certificate authority, a plurality of certified IFCL hashes; and
generating, in the cryptographic certification library, the set of certified IFCL hash lists, each IFCL hash list of the set of certified IFCL hash lists corresponding to a respective CPACF instruction of a set of CPACF instructions.

6. A computer-implemented method, comprising:
providing, to an operating system service and by a program running on a device, a call indicative of a target central processor assist cryptographic facility (CPACF) instruction associated with the device and an instruction firmware code level (IFCL) hash associated with the target CPACF instruction;
obtaining, from the operating system service and based on the call, a query result associated with a query of a cryptographic certification library, the query result indicating whether the IFCL hash is a certified IFCL hash; and
performing an action based on the query result.

7. The computer-implemented method of claim 6, wherein the action comprises:
refraining from using the target CPACF instruction if the query result indicates that the IFCL hash is not a certified IFCL hash.

8. The computer-implemented method of claim 7, further comprising:
reporting that the target CPACF instruction will not be used.

9. The computer-implemented method of claim 6, wherein the action comprises:
using the target CPACF instruction if the query result indicates that the IFCL hash is a certified IFCL hash.

10. The computer-implemented method of claim 6, further comprising:
determining that an IFCL version number associated with the IFCL hash has changed.

11. The computer-implemented method of claim 10, further comprising:
reporting that the IFCL version number has changed.

12. The computer-implemented method of claim 11, wherein reporting that the IFCL version number has changed comprises:
reporting that the IFCL version number has changed while the program is running.

13. The computer-implemented method of claim 10, further comprising:
stopping, based on determining that the IFCL version number has changed, use of the target CPACF instruction.

14. The computer-implemented method of claim 6, further comprising:
providing, in accordance with a periodicity, at least one additional call to the operating system service.

15. A computer program product comprising:
one or more computer-readable storage media; and
program instructions stored on the one or more computer-readable storage media to perform operations comprising:
providing, to an operating system service and by a program running on a device, a call indicative of a target central processor assist cryptographic facility (CPACF) instruction associated with the device and an instruction firmware code level (IFCL) hash associated with the target CPACF instruction;
obtaining, from the operating system service and based on the call, a query result associated with a query of a cryptographic certification library, the query result indicating whether the IFCL hash is a certified IFCL hash; and
performing an action based on the query result.

16. The computer program product of claim 15, wherein the action comprises:
refraining from using the target CPACF instruction if the query result indicates that the IFCL hash is not a certified IFCL hash.

17. The computer program product of claim 15, wherein the action comprises:
using the target CPACF instruction if the query result indicates that the IFCL hash is a certified IFCL hash.

18. The computer program product of claim 15, the operations further comprising:
determining that an IFCL version number associated with the IFCL hash has changed.

19. The computer program product of claim 18, the operations further comprising:
reporting, to the operating system, that the IFCL version number has changed.

20. The computer program product of claim 18, the operations further comprising:
stopping, based on determining that the IFCL version number has changed, use of the target CPACF instruction.
